(19) United States
(12) Patent Application Publication
(10) Pub. No.: US 2017/0212071 A1
(43) Pub. Date: Jul. 27, 2017

(54) WORKING ELECTRODE HOLDER AND ELECTROCHEMICAL CELL

(71) Applicant: Danmarks Tekniske Universitet, Kgs. Lyngby (DK)

(72) Inventors: Adam C. STOOT, Copenhagen N (DK); Ross BIRNEY, Renfrewshire (GB); Timothy John BOOTH, Virum (DK)

(21) Appl. No.: 15/329,281

(22) PCT Filed: Jul. 28, 2015
(86) PCT No.: PCT/EP2015/067215

§ 371 Date: Jan. 26, 2017

(30) Foreign Application Priority Data
Jul. 29, 2014 (EP) 14178928.9

(51) Int. Cl. G01N 27/28; G01N 17/02

(52) U.S. Cl. CPC G01N 27/283; G01N 17/02

(57) ABSTRACT

The present disclosure relates to a holder for a test object, more specifically to a holder for measuring electrochemical properties of the test object. One embodiment relates to a working electrode holder for measuring electrochemical properties of a front surface of a test object in a liquid, comprising: a housing comprising a bottom surface and a sidewall, the sidewall defining a first opening such that the test object can be placed inside the housing via the first opening and such that the front surface is facing the inner bottom surface; one or more electrically conductive pin(s) fixed to the bottom surface inside the housing such that the front surface of the test object is able to be placed on the pin(s), thereby providing an electrically contacted front surface, such that the electrically contacted front surface is able to operate as the working electrode; a second opening located in the bottom surface and configured for passage of said liquid, such that liquid is able to pass onto the electrically contacted front surface. The holder may be used in an electrochemical cell.

### FIELD OF INVENTION

The present disclosure relates to a holder for a test object, more specifically to a holder for measuring electrochemical properties of the test object. The holder may be used in an electrochemical cell.

### BACKGROUND OF INVENTION

Electrochemical experiments are generally conducted using a two- or three-electrode setup. Such setups comprise a working electrode, which is the test object or material under investigation; a counter electrode, made of an inert material, which needs to be stable and unreactive under the conditions used within the electrochemical cell (hence, platinum or graphite are often used); and, optionally, a reference electrode, which takes no part in the electrochemical reaction(s) under investigation and provides a stable and known reference potential. All the electrodes are placed in electrical contact with the electrolyte of an electrochemical cell, i.e. the electrodes are in a container with a liquid electrolyte. The potentials and resulting electrical currents of the reactions of interest are measured with respect to this reference potential (voltammetry).

The three electrodes are connected to a potentiostat, which is an electronic instrument that controls the voltage difference between the working electrode and reference electrode. Many potentiostats are capable of other measurements as well, in which they might control and/or measure the current over time between the counter and working electrodes whilst controlling and/or measuring the voltage with respect to the reference (chronoamperometry, chronopotentiometry).

To be able to accurately measure the electrochemical properties of a test object, the area exposed to the chosen electrolyte must be known, as the surface current density is more important than the absolute value of the current. The test object should also be contacted to the potentiostat in such a way that any electrically conductive or chemically reactive parts beyond the working electrode surface (such as wiring, soldering and crocodile clips) do not come into contact with the electrolyte and affect the measurements via corrosion, reaction with the electrolyte or short circuit, and interfere with the measurement.

Measuring the electrochemical properties of a test object, including measuring corrosion, is typically done in a cell, which often takes the form of an open-ended vessel or tube, with one end of the cell accommodating an O-ring. The test object can then be placed in mechanical contact with the O-ring, typically with the front side facing the O-ring, and screws or clamps can be tightened to hold the test object in contact with the O-ring. The backside of the test object can then be connected to a potentiostat using e.g. soldering or crocodile clips. After fixing the test object in place, the test object forms a liquid tight seal at one end of the cell, which can then be filled with electrolyte. The two remaining electrodes are immersed in the electrolyte and experiments can thereby be conducted. An open ended tube, wherein a test object is placed such that the back surface of the test object is connected using alligator clips, is disclosed in the instruction manual for the Model K0070 Corrosion Cell System from Princeton Applied Research.

There are many problems in measuring electrochemical properties of a test object according to above described devices and method. First of all, the insertion and fixation of the test object is difficult. Secondly, the establishment of electrical contact to the test object is provided by means of a rather complicated procedure. Thirdly, the electrical connection contacts the back side of the test object, such that it may be difficult to work with coated materials and other test objects that may contain an insulating layer or coating. Examples of electrical contact established to a backside of a test-object and where liquid is in contact with the front side only, are disclosed in WO 2014/008942 and GB 2 168 161. Finally, in most electrochemical cells it is necessary to empty the electrolyte from the cell when exchanging the test sample, because the sample is an integrated part of the cell. GB 2 168 161 is an example of this. This increases the likelihood of introducing contamination or other inconsistencies when emptying and replacing the electrolyte for further or repeated experiments.

### SUMMARY OF INVENTION

It is desirable to have a system whereby the test object functioning as the working electrode is easily interchangeable, in order to make multiple measurements and measurement of different materials under the same conditions simpler and to remove the need to form a permanent or semi-permanent connection to the material using solder, conductive paints, or epoxy, etc. For some applications it is also desirable to have an electrical connection to the front side of the test object. This makes it possible to work with coated materials and materials with heterogeneous electrical characteristics through their thickness—such samples may contain a highly insulating layer or coating which would interfere with or prevent accurate measurement.

In order to solve the above described problems and provide a solution for the desired needs, the present disclosure provides a working electrode holder for measuring electrochemical properties of a front surface of a test object in a liquid, comprising: a housing comprising a bottom surface and a sidewall, the sidewall defining a first opening such that the test object can be placed inside the housing via the first opening and such that the front surface is facing the inner bottom surface; one or more electrically conductive pin(s) fixed to the bottom surface inside the housing such that the front surface of the test object is able to be placed on the pin(s), thereby providing an electrically contacted front surface, such that the electrically contacted front surface is able to operate as the working electrode; a second opening located in the bottom surface and configured for passage of said liquid, such that liquid is able to pass onto the electrically contacted front surface.

The working electrode holder according to the present disclosure may be inserted into an existing electrochemical vessel-which may simply consist of electrolyte in a beaker. The working electrode holder may contain the test object, but only a known area of the front side of the test object may be exposed to the electrolyte. The test object itself may be inserted into the working electrode holder according to the present disclosure while the electrochemical cell or beaker has already been prepared and filled with an electrolyte. The insertion of the test object into the working electrode holder according to the present disclosure is very simple; the test object may simply be put inside the working electrode holder by hand. By having the one or more electrically conductive pin(s) fixed to the bottom surface inside the housing such that the front surface of the test object is able to be placed on the pin(s), thereby providing an electrically contacted front surface, such that the electrically contacted front surface is able to operate as the working electrode, there is provided means for efficiently providing a working electrode. In other words, electrical contact can be established quickly to the front surface, and especially without soldering or attaching alligator clips.

The working electrode holder according to the present disclosure is intended to be used in electrochemical cells, in particular for corrosion experiments. Accordingly, the holder according to the present disclosure is intended to be placed inside an electrochemical cell or a beaker containing a liquid.

The working electrode holder according to the present disclosure, may contact the front side of the test object, i.e. the surface of the test object configured as working electrode may be the front side of the test object, making it possible to work with coated materials and other test object that may contain an insulating layer or coating.

An effect of the having the test object in the working electrode holder according to the present disclosure is that it makes it possible to keep the electrolyte in the cell and reuse it for further or repeat experiments.

An effect of having the pin(s) fixed to the bottom surface inside the housing is that the front surface of the test object is able to be positioned in contact with the one or more pin(s) such that an electrically conductive surface of the test object is facing the bottom surface of the housing. In this way, there may be established a good electrical contact in an efficient manner between the pin(s) and electrically conductive surface. Good mechanical contact to the sample may facilitate good electrical contact. The placement of the test object is as previously described via the first opening, and may allow for a placement and removal of the test object. Further, the test object may be easily and/or quickly placed into and/or removed from the holder. Another effect is that the liquid may be able to pass directly toward the electrically conductive surface of a test object facing the bottom surface of the housing, in particular because the second opening is placed at the bottom surface of the housing.

The pin(s) may be any suitable pin(s) that are electrically conductive, such as spring loaded pins.

The present disclosure is further related to an electrochemical cell for measuring electrochemical properties of a test object, comprising: a container containing a liquid; an electrode; and a working electrode holder as described in said liquid and with said test object in said holder.

### DESCRIPTION OF DRAWINGS

FIG. 1 shows an embodiment of the working electrode holder according to the present disclosure from a perspective.

FIG. 2 shows an embodiment of the housing according to the present disclosure from below.

FIG. 3 shows an embodiment of the housing according to the present disclosure from above.

FIG. 4 shows an embodiment of the housing according to the present disclosure from the side.

FIG. 5 shows an embodiment of the housing according to the present disclosure from a perspective.

FIG. 6 shows an embodiment of the housing according to the present disclosure from a perspective.

FIG. 7 shows an embodiment of the attachment means according to the present disclosure from the side.

FIG. 8 shows an embodiment of the attachment means according to the present disclosure from an end.

FIG. 9 shows an embodiment of the attachment means according to the present disclosure from a perspective.

FIG. 10 shows an embodiment of the holding means according to the present disclosure from the side.

FIG. 11 shows an embodiment of the holding means according to the present disclosure from the top.

FIG. 12 shows an embodiment of the holding means according to the present disclosure from a perspective.

FIG. 13 shows an embodiment of a spacer according to the present disclosure.

### DETAILED DESCRIPTION

### Housing and Holding Means

In one embodiment of the present disclosure, the housing is configured for containing said test object comprising a circular surface with a diameter of at least 2.5 cm, 5 cm, 7.5 cm, 10 cm, 12.5 cm or at least 15 cm in a plane parallel to the bottom surface inside the housing. In such configuration, the housing may be configured for containing a wafer with the standard measures such as 1″, 2″, 3″, 4″, 5″ or 6″. However, in some embodiments, the housing is configured for containing said test object comprising a circular surface with a diameter of less than 2.5 cm.

In another embodiment of the present disclosure, the height of said side wall is at least 5 mm, 10 mm, 15 mm, 20 mm, 25 mm, 30 mm, 35 mm, 40 mm, 45 mm, or at least 50 mm.

In a preferred embodiment of the present disclosure, the housing is configured for providing electrical wiring to said pins. Accordingly, there may be one or more hole(s) going through the housing, such as through the sidewall or through the bottom surface. By having wiring to the pins, electrical connection is made to the front surface of the test object once the test object is placed inside the holder according to the present disclosure. In this sense, the electrical connection is automatically established and the user is not required to make the connection to the test object, for example by soldering a wire to the test object. Accordingly, the placement of the test object is easy and fast.

The housing may be any suitable shape, for example it may be shaped for a specific test object. Preferably, the cross section of the housing may be circular, square, rectangular or triangular.

Furthermore, the housing may be configured for receiving holding means for holding the test object in place between the pin(s) and said holding means. In a preferred embodiment, the holding means is a lid. The lid may be any suitable lid, for example it may be screwed or press fit into the first opening, thereby pressing the test object towards the pin(s). An effect of having holding means as described is that the holding means due to its pressure on the test object facilitate a good mechanical and electrical contact between the test object and the pin(s). Even further, the holding means may be configured to fit into said first opening, such that said liquid can only passage through the second opening. In this way, the second opening may face an electrically conducting surface of the test object, such that liquid may be directed directly onto the electrically conducting surface. All electrical contacts may be connected by placing the holding means in the first opening, for example, by screwing a lid, such that this is done using a single and simple movement. The holding means may facilitate that sealing and fixation of the test object is done easily as well.

In a preferred embodiment of the present disclosure, the housing and/or holding means are made of electrically insulating materials. In this regard, the working electrode holder according to the present disclosure may be completely free of metallic parts that can corrode (except the wires), and thus the working electrode holder according to the present disclosure is optimal for an environment comprising a liquid. Accordingly, the present disclosure is optimized for being used for corrosive test where the holder and the test object is placed in the liquid.

Additionally, the holding means may comprise an O-ring. Also, the bottom inner surface, such as the inner surface of the bottom, may comprise an O-ring.

### Pins

In a preferred embodiment of the present disclosure, the pins are three pins placed equidistant from each other. More preferably, the pins are three pins placed equidistant from said second opening. The purpose of the pins may be to establish good electrical contact.

### Spacer

In one embodiment of the present disclosure, there is a spacer that comprises one or more plate(s), to be placed between the test object and a lid to be inserted in the first opening.

In a preferred embodiment, the spacer is a facilitating that the test object is pushed further towards the pins such that a better contact is established.

Alternatively, the spacer may be integrated into a lid, e.g. as a part that can be adjusted with a screw-mechanism.

### Test object

In one embodiment of the present disclosure, the test object is a composite of layers. All of the layers need not to be electrically conductive, and thus the test object may be a non-conducing test object, i.e. the test object may not be electrically conductive through all layers. An effect of the present disclosure is that the working electrode holder works with such non-conductive test objects. The test object may be a wafer or a wafer sample, in particular a multilayer wafer or wafer sample. The test object may comprise a circular surface with a diameter of at least a 1″, 2″, 3″, 4″, 5″ or at least 6″. However, in some embodiments, the test object may comprise a circular surface with a diameter of less than 1″.

### Attachment Means

In a preferred embodiment of the present disclosure, the housing further comprises attachment means for attaching said working electrode holder to an attachment holder. In this way, it may be possible to place the working electrode holder inside an electrochemical cell or beaker such that the attachment holder holds the working electrode holder at a given position inside the electrochemical cell or beaker.

In a more preferred embodiment of the present disclosure, the attachment means is a rod attached to said sidewall, such that said attachment means extends from an outer surface of said sidewall. The attachment means may be configured for providing electrical wiring to said pins, for example there may be a hole going through the attachment means, such as through a rod. The wiring may then be further connected to a device able to measure the electrochemical properties of the test object in electrical contact with the pins.

### Further Electrodes

In order to measure the electrochemical properties of the test object, a counter electrode is placed somewhere in the liquid. In one embodiment of the present disclosure, the housing or holding means or attachment means comprises one counter electrode.

Additionally, it may be required that there is a reference electrode in the liquid in order to measure the electrochemical properties of the test object. In another embodiment of the present disclosure, the housing or holding means or attachment means comprises one reference electrode.

### Openings

Preferably, the second opening is positioned such that liquid can passage into a test area of said test object. For example, the second opening may be in the centre of said bottom surface. Alternatively, the second opening may be at an off-centre position. There may be one or more second openings. Accordingly, there may both be an opening at the centre of the bottom surface and/or at an off-centre, such as of the bottom surface and/or of the sidewall and/or of the lid. In some embodiments, there may be second openings, i.e. additional openings, the additional openings may be at the sidewall, at the holding means, or at the lid.

In one embodiment of the present disclosure, the second opening has an area of such as less than 10 cm², such as less than 9 cm², such as less than 8 cm², such as less than 7 cm², such as less than 6 cm², such as less than 5 cm², such as less than 4 cm², such as less than 3 cm², such as less than 1 cm², such as less than 1 cm². In some embodiments, the second opening has an area of such as more than 10 cm², such as more than 20 cm², such as more than 30 cm², such as more than 40 cm², or such as more than 50 cm²

### Electrochemical Cell

The electrochemical cell according to the present disclosure may comprise one or more of the described feature(s). The electrode may be a counter electrode and or a reference electrode attached to said working electrode holder. The counter electrode is essential for having an electrochemical cell according to the present disclosure, but as just described, the counter electrode may not need to be in the container but may be a part of the holder according to the present disclosure. Such configuration may simplify an electrochemical cell by collecting all the electric wires in one place, namely on the holder.

### EXAMPLES

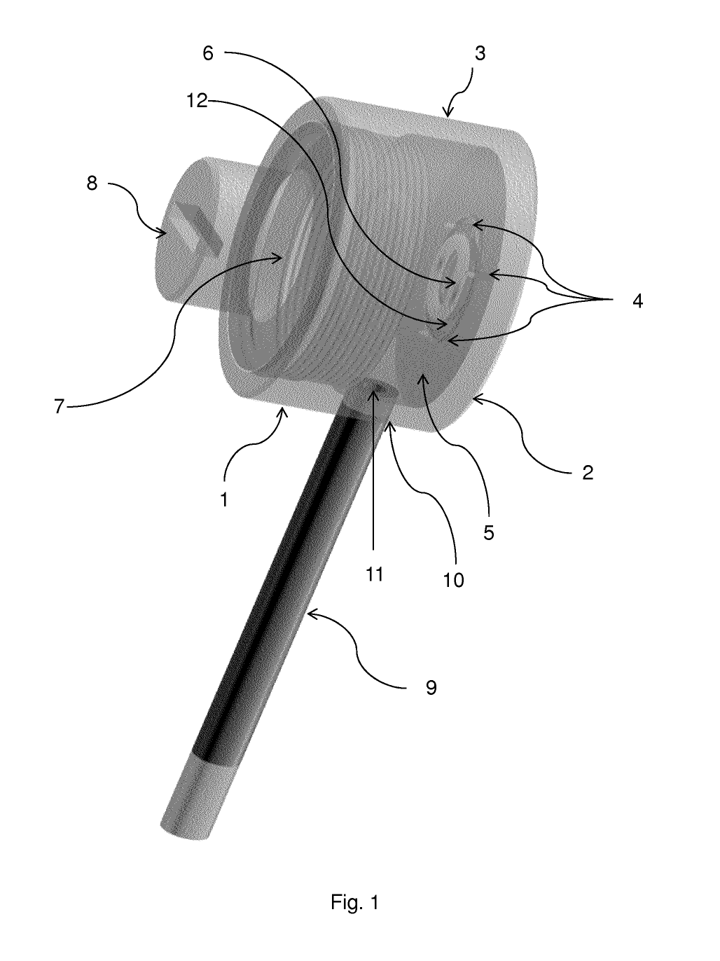

FIG. 1 shows an embodiment of the working electrode holder according to the present disclosure from a perspective. FIG. 1 shows a working electrode holder for measuring electrochemical properties of a test object in a liquid, comprising: a housing 1 comprising a bottom surface 2 and a sidewall 3; one or more electrically conductive pin(s) 4 positioned on a bottom surface 5 inside the housing 1; a second opening 6 configured for passage of said liquid; and a first opening 7 configured for receiving said test object such that a surface of the said object configured as working electrode can be placed in contact with said pin(s) 4 and liquid. The housing is configured for receiving holding means 8 for holding said test object in place between said pins and said holding means. In this case, the housing is with threading, and the holding means 8 is a lid, configured to fit into the housing. In order to tighten the lid, there is a groove on the lid. Further, the holding means 8 is configured to fit into said first opening 7, such that said liquid can only passage through said second opening 6. In this example, the housing is configured for containing the test object comprising a circular surface with a diameter of at least 2.5 cm in order hold a standardized 1-inch test object in a plane parallel to said bottom surface 5 inside the housing. Accordingly, the cross section of said housing is circular. The second opening is in said bottom surface, specifically at the in the centre, positioned such that said liquid can passage into a test area of said test object. The housing further comprises attachment means 9 for attaching said working electrode holder to an attachment holder. The housing is configured for providing electrical wiring to said pins, and therefore there is a hole 10 going through the sidewall 3. The pins are three pins 4 placed equidistant from each other and also placed equidistant from said second opening 6. The attachment means 9 is a rod attached to said sidewall 3, such that said attachment means 9 extends from an outer surface of said sidewall 3. The attachment means 9 is configured for providing electrical wiring to said pins 4, and therefore there is a hole 11 going through the rod.

The bottom inner surface 5 comprises an O-ring 12 to seal the second opening 6 with a test object, when a test object is placed on the O-ring. Wiring is able to be connected to the pins and into the hole 11 through the rod.

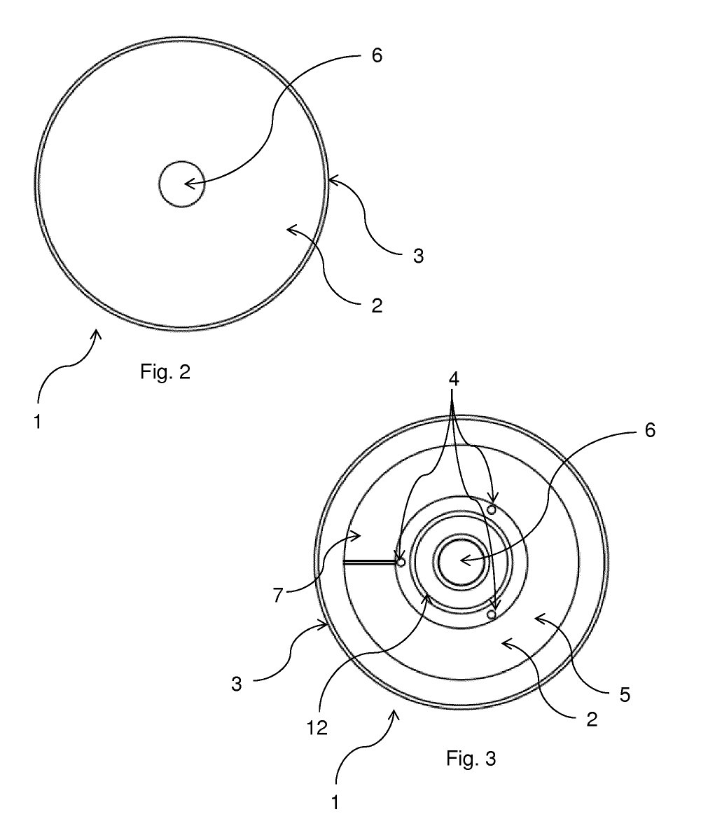

FIG. 2 shows an embodiment of the housing according to the present disclosure from below. FIG. 2 shows a housing 1 comprising a bottom surface 2 and a sidewall 3; and a second opening 6 configured for passage of said liquid.

FIG. 3 shows an embodiment of the housing according to the present disclosure from above. FIG. 3 shows a housing 1 comprising a bottom surface 2 and a sidewall 3;

one or more electrically conductive pin(s) 4 positioned on a bottom surface 5 inside the housing 1; a second opening 6 configured for passage of said liquid; and a first opening 7 configured for receiving said test object such that a front surface of the said object configured as working electrode can be placed in contact with said pin(s) and liquid. The bottom inner surface 5 comprises an O-ring 12 to seal the second opening 6 with a test object, when a test object is placed on the O-ring.

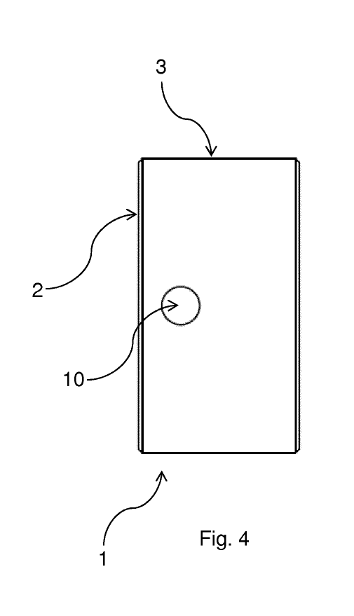

FIG. 4 shows an embodiment of the housing according to the present disclosure from the side. FIG. 4 shows a housing 1 comprising a bottom surface 2 and a sidewall 3. The housing is configured for providing electrical wiring to said pins, and therefore there is a hole 10 going through the sidewall 3.

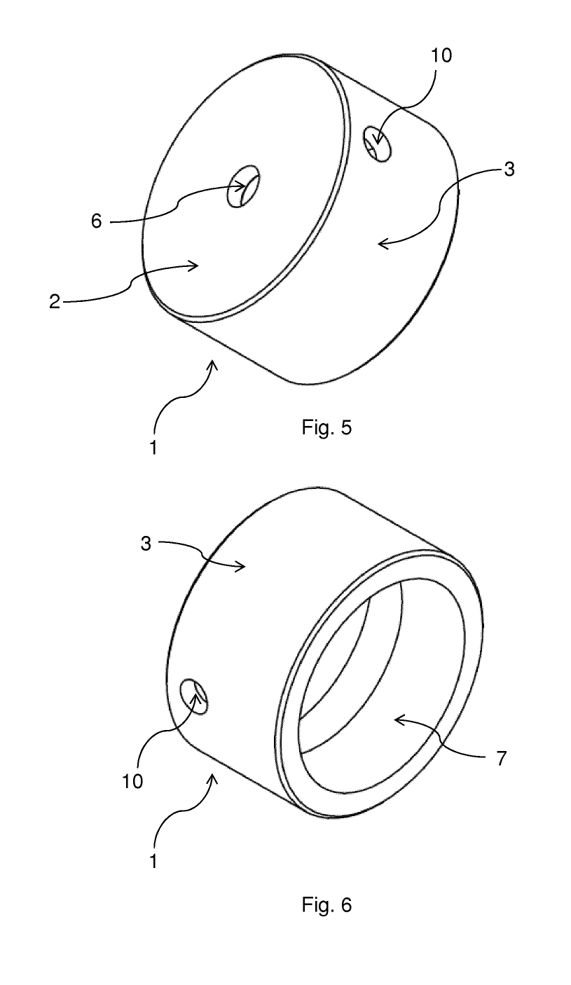

FIG. 5 shows an embodiment of the housing according to the present disclosure from a perspective. FIG. 5 shows a housing 1 comprising a bottom surface 2 and a sidewall 3; and a second opening 6 configured for passage of said liquid. The housing is configured for providing electrical wiring to said pins, and therefore there is a hole 10 going through the sidewall 3.

FIG. 6 shows an embodiment of the housing according to the present disclosure from a perspective. FIG. 6 shows a housing 1 comprising a sidewall 3; and a first opening 7 configured for receiving said test object such that a front surface of the object configured as working electrode can be placed in contact with said pin(s) and liquid. The housing is configured for providing electrical wiring to said pins, and therefore there is a hole 10 going through the sidewall 3.

FIG. 7 shows an embodiment of the attachment means 9 according to the present disclosure from the side. The attachment means 9 is a rod.

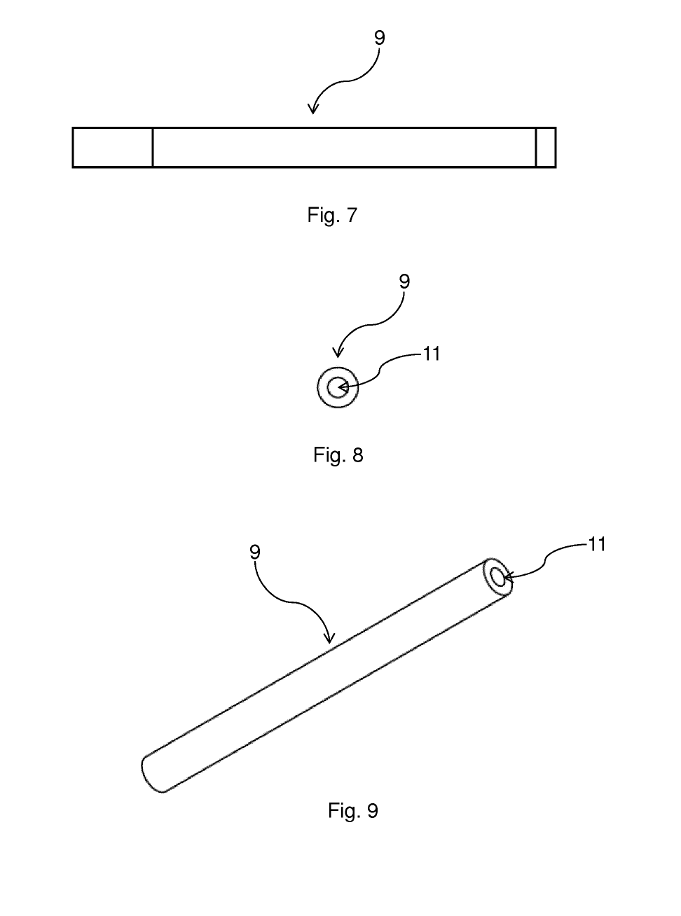

FIG. 8 shows an embodiment of the attachment means 9 according to the present disclosure from an end. The attachment means 9 is a rod. The attachment means 9 is configured for providing electrical wiring to said pins, and therefore there is a hole 11 going through the rod.

FIG. 9 shows an embodiment of the attachment means 9 according to the present disclosure from a perspective. The attachment means 9 is a rod. The attachment means 9 is configured for providing electrical wiring to said pins, and therefore there is a hole 11 going through the rod.

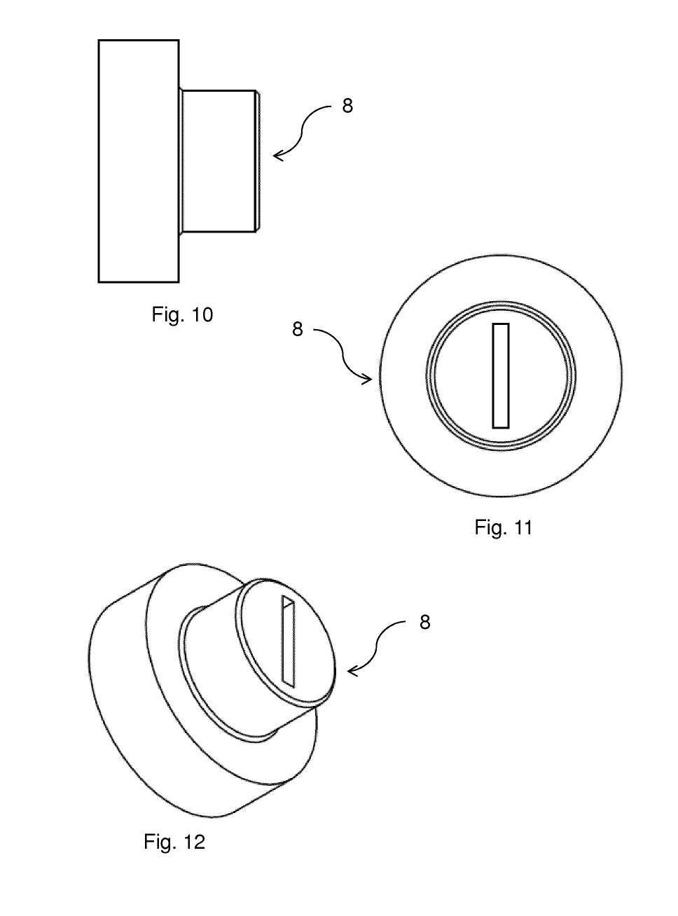

FIG. 10 shows an embodiment of the holding means according to the present disclosure from the side. The holding means 8 is for holding said test object in place between said pins and said holding means. The holding means 8 is a lid, configured to fit into the housing. There may be threading on the lid but this is not shown. In order to tighten the lid, there is a groove on the lid. Furthermore, the holding means may comprise one or more O-ring(s) but this is not shown.

FIG. 11 shows an embodiment of the holding means according to the present disclosure from the top. The holding means 8 is for holding said test object in place between said pins and said holding means. There may be threading on the lid but this is not shown. The holding means 8 is a lid, configured to fit into the housing. In order to tighten the lid, there is a groove on the lid. Furthermore, the holding means may comprise one or more O-ring(s) but this is not shown.

FIG. 12 shows an embodiment of the holding means according to the present disclosure from a perspective. The holding means 8 is for holding said test object in place between said pins and said holding means. There may be threading on the lid but this is not shown. The holding means 8 is a lid, configured to fit into the housing. In order to tighten the lid, there is a groove on the lid. Furthermore, the holding means may comprise one or more O-ring(s) but this is not shown.

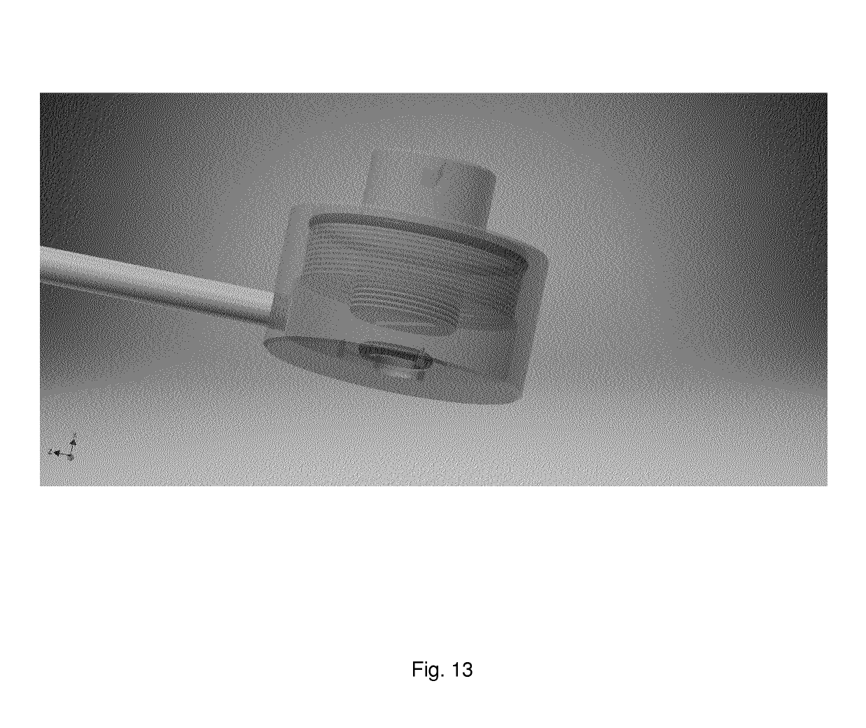

FIG. 13 shows an embodiment of the spacer according to the present disclosure. In this case, the spacer is placed inside the housing, for example such that a test object can be placed below the spacer, whereby the lid is able to press more on the test object, in comparison to if the spacer was not present.

1. A working electrode holder for measuring electrochemical properties of a front surface of a test object in a liquid, comprising:
a housing comprising a bottom surface and a sidewall, the sidewall defining a first opening such that the test object can be placed inside the housing via the first opening and such that the front surface is facing the inner bottom surface;
one or more electrically conductive pin(s) fixed to the bottom surface inside the housing such that the front surface of the test object is able to be placed on the pin(s), thereby providing an electrically contacted front surface, such that the electrically contacted front surface is able to operate as the working electrode; and
a second opening located in the bottom surface and configured for passage of said liquid, such that liquid is able to pass onto the electrically contacted front surface.

2. The working electrode holder according to claim 1, wherein said housing is configured for containing said test object comprising a circular surface with a diameter of at least 2.5 cm, 5 cm, 7.5 cm, 10 cm, 12.5 cm or at least 15 cm in a plane parallel to said bottom surface inside the housing.

3. The working electrode holder according to any of the preceding claims, wherein said housing is configured for providing electrical wiring to said pins.

4. The working electrode holder according to any of the preceding claims, wherein said housing is configured for receiving holding means for holding said test object in place between said pins and said holding means.

5. The working electrode holder according to any of the preceding claims, wherein the cross section of said housing is circular, square, rectangular or triangular.

6. The working electrode holder according to any of the preceding claims, wherein said holding means is a lid.

7. The working electrode holder according to any of the preceding claims, wherein said housing and/or holding means are made of electrically insulating materials.

8. The working electrode holder according to any of the preceding claims, wherein said holding means comprises one or more O-ring(s).

9. The working electrode holder according to any of the preceding claims, wherein said holding means is configured to fit into the first opening, such that said liquid can only pass through the second opening.

10. The working electrode holder according to any of the preceding claims, wherein the height of said sidewall is at least 5 mm, 10 mm, 15 mm, 20 mm, 25 mm, 30 mm, 35 mm, 40 mm, 45 mm, or at least 50 mm.

11. The working electrode holder according to any of the preceding claims, wherein said pins are three pins placed equidistant from each other.

12. The working electrode holder according to any of the preceding claims, wherein said pins are three pins placed equidistant from said second opening.

13. The working electrode holder according to any of the preceding claims, wherein said test object is a composite of layers.

14. The working electrode holder, according to any of the preceding claims, wherein said housing further comprises attachment means for attaching said working electrode holder to an attachment holder.

15. The working electrode holder according to any of the preceding claims 14, wherein said attachment means is a rod attached to said sidewall, such that said attachment means extends from an outer surface of said sidewall.

16. The working electrode holder according to any of the preceding claims 14-15, wherein said attachment means is configured for providing electrical wiring to said pins.

17. The working electrode holder according to any of the preceding claims, wherein said housing or holding means or attachment means comprises one counter electrode.

18. The working electrode holder according to any of the preceding claims, wherein said housing or holding means or attachment means comprises one reference electrode.

19. The working electrode holder according to any of the preceding claims, wherein the second opening is positioned such that liquid can pass into a test area of the front surface of the test object.

20. The working electrode holder according to any of the preceding claims, wherein the second opening is in the centre of said bottom surface.

21. The working electrode holder according to any of the preceding claims, wherein the second opening is at an off-centre position.

22. The working electrode holder according to any of the preceding claims, wherein the second opening has an area of less than 10 cm², more preferably less than 8 cm², even more preferably less than 6 cm², yet more preferably less than 4 cm², most preferably less than 2 cm².

23. The working electrode holder according to any of the preceding claims, wherein the bottom surface inside the housing comprises an O-ring.

24. An electrochemical cell for measuring electrochemical properties of a test object, comprising
a container containing a liquid, an electrode; and
a working electrode holder according to any of the preceding claims in said liquid and with said test object in said holder.

25. The electrochemical cell according to claim 24, wherein said electrode is a counter electrode and/or a reference electrode attached to said working electrode holder.
